(19) United States
(12) Patent Application Publication
(10) Pub. No.: US 2007/0133793 A1
(43) Pub. Date: Jun. 14, 2007

(54) Data processor and data processing method

(75) Inventor: Takuji Kimura, Oume-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/634,967

(22) Filed: Dec. 7, 2006

(30) Foreign Application Priority Data
Dec. 12, 2005 (JP) 2005-358326

(51) Int. Cl. G09C 5/00

(52) U.S. Cl. 380/54

(57) ABSTRACT

According to one embodiment, a data processing method of a data processor for storing data into a recording medium having a first storage area which allows access from only specific applications complying with a copyright protection technique and a second storage area which allows access from the specific applications and other applications, the data processing method comprises: generating a packet having a nonencrypted portion including copy control information showing conditions for copying the data and an encrypted portion including the copy control information and predetermined information arranged at predetermined positions; and storing a file containing a plurality of packets into the second storage area of the recording medium.

### CROSS-REFERENCE TO RELATED APPLICATIONS

This application is based upon and claims the benefit of priority from Japanese Patent Application No. 2005-358326, filed on Dec. 12, 2005, the entire contents of which are incorporated herein by reference.

### BACKGROUND

1. Field

One embodiment of the present invention relates to a data processor and a data processing method.

2. Description of the Related Art

In Japan, a digital terrestrial broadcast having a 13-segment structure has already been tested.

In the digital terrestrial broadcast, only one center segment of the 13 segments can be received. Initiation of a one-segment digital broadcast; i.e., a so-called one-segment broadcast, for a cellular phone or a mobile unit is under consideration.

Standardization for recording a one-segment broadcast into a storage medium such as a memory card is now being contemplated.

When a copyright-protected digital broadcast is received by a digital tuner and when an obtained video content is recorded into a memory card complying with the SD-Video standards (e.g., an SD (Secure Digital) memory card) by means of a CPRM (Content Protection for Recordable Media) technique, copy control information (hereinafter abbreviated as “CCI”) is recorded in a secure area of the SD memory card.

A one-segment broadcast is utilized on the assumption that the SD memory card is set in a portable receiving terminal having comparatively low processing performance, and the received video content is assumed to be recorded in the SD memory card.

In this case, it is necessary to reduce a processing load, by decreasing the number of times files are divided according to a change in CCI or the number of times access is made to the secure area in association with the division of data into files.

For these reasons, recording encrypted CCI in a storage area in the SD memory card where the user can readily make access (hereinafter called a “user area”) is desirable.

However, information, such as CCI, has a comparatively small number of bits. When CCI is recorded in an encrypted manner in the user area, CCI can be tampered with in an unauthorized manner by means of a technique such as an easy round-robin retrieval.

When fraud induced by tampering with CCI cannot be detected, an apparatus which plays back a video content may fail to normally perform copy control and cause a malfunction.

However, it may be a heavy load for a device having low processing capability, such as a portable receiver to decrypt the encrypted CCI. For example, when a list containing information about enabling/disabling of playback and copy is displayed in connection with a recorded program based on CCI, increasing the number of program lists causes a heavy load on the device. This may be a factor for impairing response of a display of the device.

An example of an information providing system is disclosed in e.g., JP-A-2001-28572. This information providing system protects a copyright of data on a medium having a security area from which third parties cannot read data and a readable data area.

In the case of this system, encrypted data and copyright protection information are stored in the data area of a medium, and key information (an encrypted content key) used for reconstructing encrypted data is stored in the security area. Even when the copyright protection information or encrypted data have been copied from the medium, reconstruction of data, i.e. playback of data, can be prevented.

In the case of above-described system, so long as CCI is stored in the secure area, unauthorized tampering with CCI becomes very difficult, which prevents copying or unauthorized playback of data.

However, setting of CCI can be changed by a party which broadcasts programs. In this case, access to the secure area arises in accordance with changes in CCI.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the configuration of a one-segment receiver according one embodiment of the present invention;

FIG. 2 is an exemplary view showing a storage area of an SD memory card which can be utilized by the one-segment receiver shown in FIG. 1;

FIG. 3 is an exemplary view showing the data configuration of a recorded content file;

FIG. 4 is an exemplary view showing the format of a control packet included in the recorded content file shown in FIG. 3;

FIG. 5 is an exemplary view showing specifics of copy control information (CCI);

FIG. 6 is an exemplary flowchart showing recording operation of a one-segment receiver;

FIG. 7 is an exemplary flowchart showing processing for storing data into a secure area;

FIG. 8 is an exemplary flowchart showing in details processing for storing data into a user area (block S103 in FIG. 6);

FIG. 9 is an exemplary view for describing encryption of data in a CBC mode;

FIG. 10 is an exemplary flowchart showing processing for copying data stored in an SD memory card;

FIG. 11 is an exemplary flowchart showing processing for reading data from the secure area;

FIG. 12 is an exemplary flowchart showing in detail reading operation (block S204 in FIG. 10) for copying a recorded content file; and

FIG. 13 is an exemplary view for describing decryption of data in the CBC mode.

### DETAILED DESCRIPTION

Various embodiments according to the invention will be described hereinafter with reference to the accompanying drawings.

In general, according to one embodiment of the invention, a data processing method of a data processor for storing data into a recording medium having a first storage area which allows access from only specific applications complying with a copyright protection technique and a second storage area which allows access from the specific applications and other applications, the data processing method comprises: generating a packet having a nonencrypted portion including copy control information showing conditions for copying the data and an encrypted portion including the copy control information and predetermined information arranged at predetermined positions; and storing a file containing a plurality of packets into the second storage area of the recording medium.

Further, according to one embodiment of the invention, a data processor for processing data stored in a recording medium having a first storage area which allows access from only specific applications complying with a copyright protection technique and a second storage area which allows access from the specific applications and other applications, the data processor comprises: a packet generating unit configured to read an encrypted file from the second storage area of the storage medium when reading of data stored in the storage medium is instructed, thereby generating a plurality of packets, each of which has a nonencrypted portion including copy control information showing conditions for copying the data and an encrypted portion including the copy control information and predetermined information arranged at predetermined positions; a fist determining unit configured to determine whether or not the predetermined information has been tampered with, by use of the predetermined information obtained by decrypting the encrypted portion of each of the packets according to a predetermined encrypting method as well as information read from the first storage area; a second determining unit configured to determine whether or not coincidence exists by means of comparing the copy control information obtained by decrypting the encrypted portion of each of the packets according to a predetermined encrypting method with copy control information obtained from the nonencrypted portion of the packet, thereby determining whether or not the copy control information has been tampered with; and a read control unit configured to abort reading of data when the copy control information is determined to have been tempered with based on one of results of the first determining unit and the second determining unit.

Furthermore, according to one embodiment of the invention, a data processor for processing data stored in a recording medium having a first storage area which allows access from only specific applications complying with a copyright protection technique and a second storage area which allows access from the specific applications and other applications, the data processor comprises: a data management information reading unit configured to read data management information from the second storage area of the storage medium when reading of desired data stored in the storage medium is instructed; a packed data reading unit configured to read packet data, which has a nonencrypted portion and an encrypted portion, from an encrypted file of the second storage area; a storing unit configured to store the read packet data, and copy control information included in the nonencrypted portion of the packet, into the memory; a decrypting unit configured to decrypt data pertaining to the encrypted portion of the packet in a chaining mode of a block cipher, through use of an encryption key specified by the data management information stored in the first storage area; a first determining unit configured to determine whether or not the predetermined information has been tampered with, by use of predetermined information included in data pertaining to a decrypted portion and information read from the first storage area; a second determining unit configured to determine whether or not coincidence exists by means of comparing the copy control information included in data pertaining to the decrypted portion with copy control information about the nonencrypted portion stored in the memory, thereby determining whether or not the copy control information has been tampered with; and a read control unit configured to abort reading of data into memory when the copy control information is determined to have been tempered with based on one of results of the first determining unit and the second determining unit.

As described above, a recording medium has the first storage area which allows access from only specific applications complying with a copyright protection technique and the second storage area which allows access from the specific applications and other applications. When copy control information is stored in an encrypted manner in the second storage area, the copy control information is set in each of a nonencrypted portion and an encrypted portion of a packet.

In relation to the encrypted portion, copy control information is set in the first block for block encryption, and predetermined information used for detecting tampering of copy control information at a position spaced from the position over a distance corresponding to the length of one block or more. The predetermined information is encrypted in a chaining mode along with the copy control information, and is stored in the second storage area. In relation to the encrypted portion, data is encrypted by use of a chaining mode in the block encryption method.

The predetermined information used for detecting tampering is stored in the secure first recording area to which the user cannot easily make access. When data is read from the storage medium, a determination as to whether or not the copy control information has been tampered with and a determination as to whether or not the predetermined information has been tampered with are performed in conjunction with each other. When at least one of the two determinations about tampering shows that tampering has been performed, reading of data from the storage medium is aborted.

As described above, according to one embodiment of the present invention, copying or playback of data through fraud can be prevented while copy control information is stored in a second storage area of a recording medium having a first storage area which allows access from only specific applications complying with a copyright protection technique and the second storage area which allows access from the specific applications and other applications.

An embodiment of the present invention will be described in detail hereinbelow by reference to the drawings.

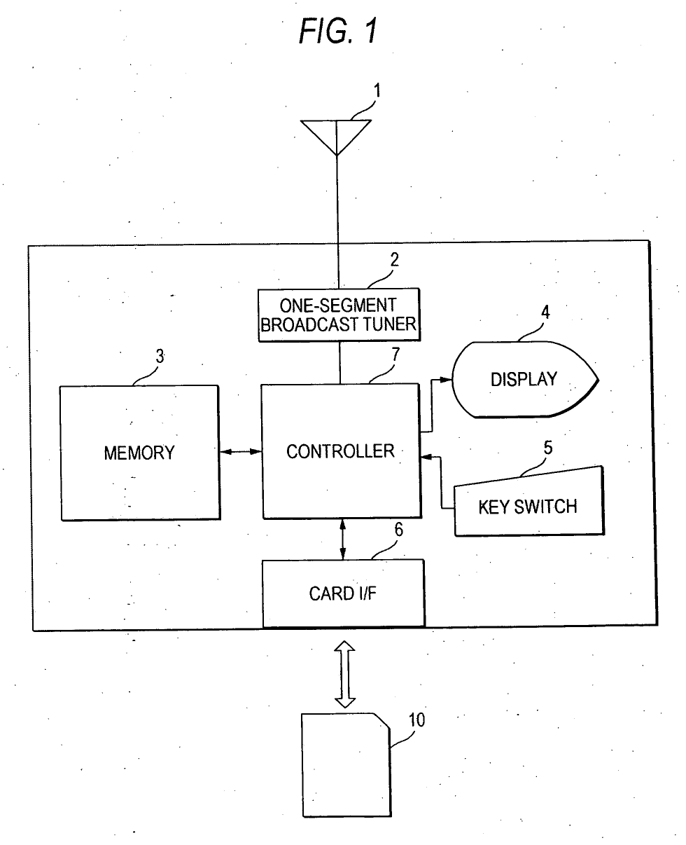

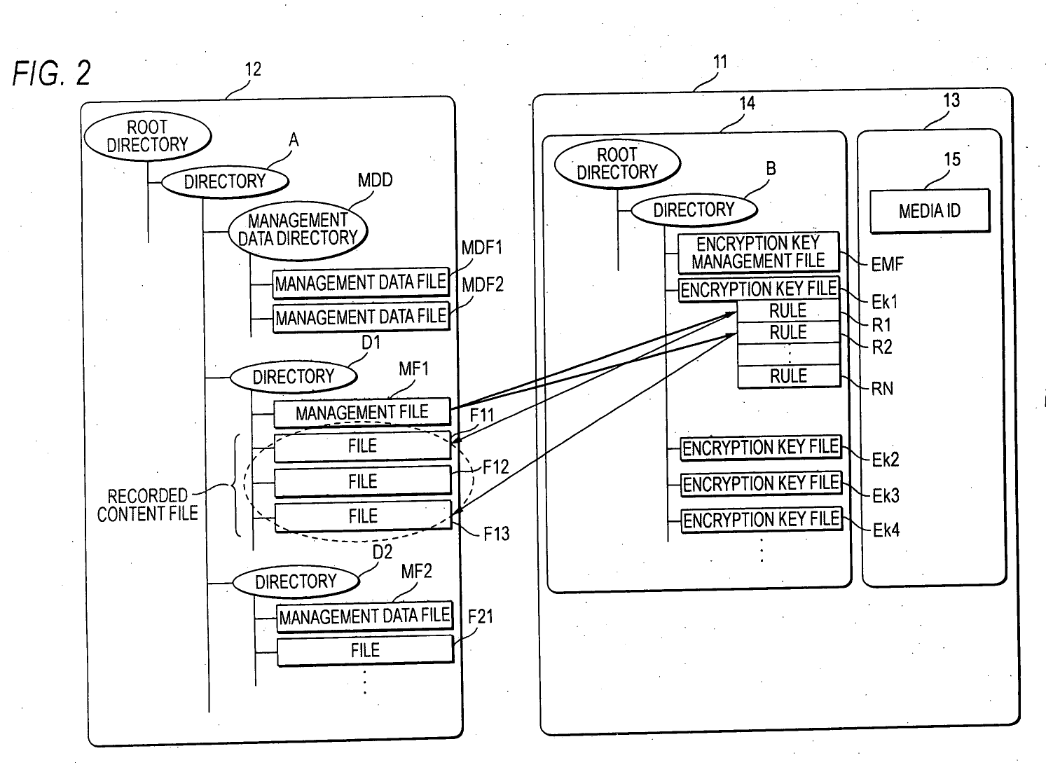

FIG. 1 is an exemplary view showing the configuration of a one-segment digital broadcast receiving recording playback apparatus (hereinafter called a “one-segment receiver”) according to an embodiment of the present invention; and FIG. 2 is an exemplary schematic view showing storage areas of an SD memory card serving as an example of a storage medium set in the one-segment receiver shown in FIG. 1.

As shown in FIG. 1, the one-segment receiver includes a one-segment digital broadcast tuner 2 (hereinafter called a “one-segment broadcast tuner 2”) connected to an antenna 1, memory 3, a display 4, a key switch 5, a card interface 6 (hereinafter called a “card I/F 6”), and a controller 7.

The one-segment broadcast tuner 2 receives a one-segment digital broadcast via the antenna 1, generates a data stream of MPEG-2 transport stream (hereinafter abbreviated as “MPEG2_TS”) through processes such as demodulation of a digital signal, and outputs the data stream to the controller 7.

While buffering the input MPEG2_TS into the memory 3, the controller 7 separates the stream into a video packet and an audio packet, and decodes the thus-separated respective packets. The thus-decoded video data and the decoded audio data are output from the memory 3 to the display 4, whereby a video of the one-segment digital broadcast is played back on a screen of the display 4.

The memory 3 stores authentication data used by the controller 7, which performs authentication processing along with an SD memory card 10 when access is made to the memory 3 from applications complying with the copyright protection function. The authentication data is a device key used in, e.g., encryption processing performed during authentication processes.

The memory 3 also stores a control program for enabling the controller 7 to perform processing operation.

The memory 3 serves as a temporary storage area for storing data to be written into the SD memory card 10 by means of the card I/f 6 or data in the SD memory card 10 having. been read by means of the card I/F 6. That is, the memory 3 serves as an input/output buffer. Data is input and output by way of the memory 3. The display 4 displays an input video on the screen.

The key switch 5 allows the user to selectively operate a receiving channel of a one-segment digital broadcast. Further, the key switch 5 inputs the instructions to the controller 7, for selecting, recording, and playing back a program to the SD memory card 10.

The controller 7 receives the instructions as a result of operation of the key switch 5, and performs control of individual sections responding to the instructions; namely, tuning control of a program, recording control, or playback control, etc.

The controller 7 serves as an example of each of following units: a packet generating unit; a first determining unit; a second determining unit; a read control unit; a data management information reading unit; a packet data reading unit; a storing unit; and a decrypting unit.

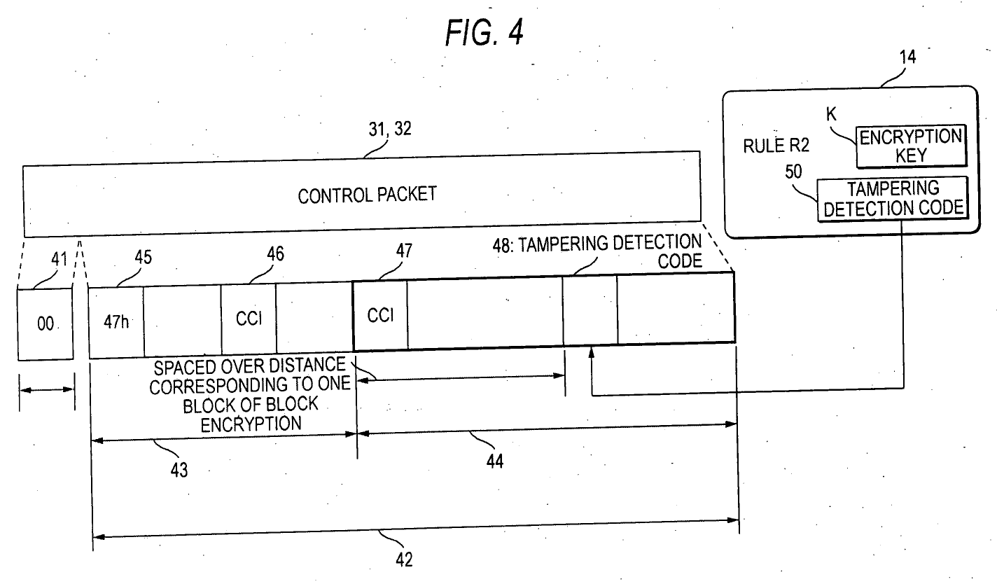

As shown in FIG. 4, the controller 7 sequentially generates control packets 31, 32, . . . Each of the control packets includes a nonencrypted portion 43 and an encrypted portion 44. In the nonencrypted portion 43, copy control information 46 (hereinafter abbreviated as “CCI 46”) showing conditions for copying data is set. In the encrypted portion 44, CCI 47 and a tampering detection code 48 (predetermined information) are arranged at predetermined positions (illustrated positions). CCI 47 is information (copy control information) identical with CCI 46. Further, the CCI 47 and the tempering detection code 48 in the encrypted portion 44 are encrypted by a predetermined encryption method according to any one of rules R1 to RN specified by an encryption key file Ek1. The predetermined encryption method is a CBC mode which is one of chaining modes of block encryption.

The controller 7 stores in a user area 12 files 30a, 30b, 30c . . . which respectively includes a plurality of the sequentially-generated packets 31, 32, . . .

When encrypting data on a per-block basis by the block encryption method to thereby arrange the CCI 47 and the tampering detection code 48 in an encrypted portion 44, the controller 7 places the CCI 47 at the start position of the block, as well as placing the tampering detection code 48 at a position spaced apart from that position over a distance corresponding to the length of one block or more.

The controller 7 uses a predetermined value as the tampering detection code 48. The controller 7 stores in an authentication area 14 of the secure area 11 a tampering detection code 50 related to the detection code 48 placed in the encrypted portion 44.

Predetermined fixed values may also be used for the tampering detection codes 48 and 50. Alternatively, there may also be used a value, which is determined from an input of packet data MPEG2_TS to be recorded through predetermined computation.

When the value is determined through computation, the controller 7 may read the values stored in the authentication area 14 when reading data from the SD memory card 10, perform predetermined computation while taking the value as a parameter to obtain a value, and use the thus-obtained value as the tampering detection code 50.

The controller 7 generates each of the tampering detection codes 48, 50 as a code of one byte or more, and stores the tampering detection code 50 into the authentication area 14.

The block encryption method is an encryption method for encrypting data on a per-block basis, and has an ECB mode and a CBC mode. The controller 7 encrypts data by use of a chaining mode; e.g., a CBC (Cipher book Chaining) mode or a C-CBC (Converted Cipher Book Chaining) mode. In this embodiment, the CBC mode is described as an example.

When copying data in the user area 12 stored in the SD memory card 10, the controller 7 generates packets in sequence reverse to that mentioned previously. The controller 7 determines whether or not data have been tampered with in an unauthorized manner in conjunction with the CCI and the tampering detection code, which are extracted from each of the packets. Then, the controller 7 outputs data in a work area of the memory 3 to the output buffer only when the data is determined to not have been tampered with.

Specifically, when an instruction for reading data stored in the SD memory card 10 has been issued by operating the key switch 5, the controller 7 first reads an encrypted file from the user area 12 of the SD memory card 10, to thus decode the file through a predetermined encryption method and generate a plurality of packets, each of which has the nonencrypted portion 43 where the CCI 46 is set and the encrypted portion 44 where the CCI 47 and the tampering detection code 48 are placed at predetermined positions.

In relation to the encrypted portion 44, when decrypting the data on a per-block basis by means of the block encryption method to thus obtain the encryption detection code 48 in conjunction with the CCI 47, the controller 7 acquires the CCI 47 from the start position of the block along with the tampering detection code 48 from the predetermined position that is spaced apart from the position by a distance corresponding to the length of one block or more.

The controller 7 decrypts the data by use of the chaining mode in the block encryption method. The controller 7 decrypts the data by use of the CBC (Cipher Book Chaining) mode or the C-CBC (Converted Cipher Book Chaining) mode as a chaining mode.

The controller 7 compares the tampering detection code 48 obtained by decrypting the encrypted portion 44 of each of the packets by means of a predetermined encryption method with the tampering detection code 50 read from the authentication area 14 of the secure area 11, to thus determine whether or not coincidence exists.

The controller 7 reads as the tampering detection code 50 a 2-bit or 4-bit code from the authentication area 14 of the secure area 11.

The controller 7 compares the CCI 47 obtained by decrypting the encrypted portion 44 of each of the packets by means of a predetermined encryption method with the CCI 46 obtained from the nonencrypted area 43 of the same packet, to thus determine whether or not coincidence exists. Thereby, a determination is made as to whether or not the CCI 46 has been tampered with.

When one of the results of comparative determination indicates a mismatch, the controller 7 determines that the data have been tampered with. Then, the controller aborts output of the data in the work area of the memory 3 to the applications via the output buffer, and also aborts reading of the data from the user area 12. In short, the controller 7 stops reading data from the SD memory card 10 into the memory 3.

The card I/F 6 is provided with an SD card slot (not shown), and performs reading and writing of data from and into the SD memory card 10 set in the SD card slot in a removable manner.

Under control of the controller 7, the card I/F 6 reads and writes data from and to the SD memory card 10 set in the SD card slot.

Under control of the controller 7, the card I/F 6 reads from the memory data to be written and writes the thus-read data into the SD memory card 10.

Under control of the controller 7, the card I/F 6 reads data from the SD memory card 10 and temporarily stores the data into the memory 3.

The SD memory card 10 is a memory card complying with CPRM (Content Protection for Recordable Media) technique which is a copyright protection function.

The SD memory card 10 has an SD I/O which serves as an SD input/output section and as an interface with the card I/F 6, a memory controller, and flash memory serving as a storage area.

As shown in FIG. 2, the flash memory of the SD memory card 10 is divided into the secure area 11 and the user area 12.

The secure area 11 includes a system area 13 and the authentication area 14. A medium ID 15 used for identifying a card is stored in the system area 13. The medium ID 15 is identification information unique to a medium, which is used for authentication at the time of reading of data. The secure area 11 is a storage area which limits access from the applications.

When an application of the device makes access to the storage medium, the device and the medium mutually authenticate each other, and the application can make access to the authentication area 14 only when authenticated.

An encryption technique using a parameter previously imparted to only an application licensed by the CPRM technique (complying with the copyright protection technique) is used for mutual authentication.

Specifically, only the applications licensed by the CPRM technique can access the authentication area 14, and the authentication area 14 is a hidden area to which ordinary applications cannot make access. This authentication area 14 is called a first storage area.

In this authentication area 14, a encryption key management file EMF, a plurality of encryption key files Ek1, . . . , Ek4, and the like, are stored in one of directories subordinate to the root directory; for example, a directory B shown in FIG. 2.

The encryption key management file EMF is a file used for managing a plurality of encryption key files Ek1, . . . , Ek4.

A plurality of rules; e.g., rule R1, rule R2, . . . , rule RN are stored in the encryption key file Ek1.

The respective rules R1, R2, . . . , RN are encryption keys used for encrypting files, into which a recorded content file has been divided, on a per-file basis.

The user area 12 is an area to which ordinary applications can make access. This storage area is a second storage area; in other words, a storage area which does not limit access from the applications.

The user area 12 is provided with one of directories subordinate to the root directory; e.g., a directory A shown in FIG. 2, and is provided with directories D1, D2, . . . and a management directory MDD.

The directories D1, D2, . . . are directories where recorded content files of respective recorded programs are stored.

A plurality of files F11, F12, F13, . . . and a management file MF1 are stored in the directory D1.

These files F11, F12, F13, . . . are formed by dividing a recorded content file into predetermined storage units and encrypting the thus-divided files.

The management file MF1 is a file of data management information used for managing reading of the plurality of files F11, F12, F13, . . . A target to which reference is to be made is specified for the purpose of an application reading data.

Rules R1 and R2 of the encryption key file Ek1 of the authentication area 14 are specified as targets in FIG. 2. Thereby, the respective files F11, F12, F13, . . . , are decrypted according to the specified rules. In this embodiment, the file F11 is decrypted according to the rule R1, and the file F13 is decrypted according to the rule R2.

A management file MF2, and the plurality of files F21, . . . , are stored in the directory D2. The files F21 . . . are encrypted files.

The management file MF2 is a file for managing the plurality of files F21, . . .

The management data directory MDD stores management data files MDF1, MDF2.

The management data files MDF1, MDF2 are files into which is stored general information about contents (e.g., a total recording time) stored in the internal directory of the directory A.

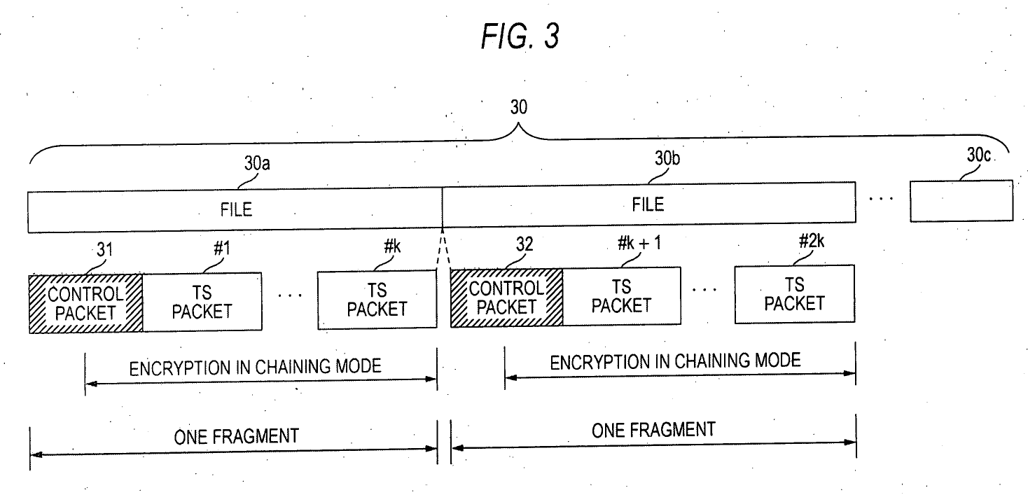

A storage format (recording format) of a recorded content file will now be described by reference to FIGS. 3 and 4.

As shown in FIG. 3, a recorded content file 30 is divided into files 30a, 30b, 30c, . . . , which are units for storage. The files are encrypted in, e.g., a chaining mode, of some encryption modes of the block encryption method, and the thus-encrypted files are stored in the user area 12 of the SD memory card 10. The chaining mode of the block encryption method will be described later.

One file contains a control packet and at least one transport stream packet (hereinafter called a “TS packet”).

As shown in FIG. 3, the first file 30a contains the control packet 31 and the TS packets #1, . . . , #k, and the next file 30b contains a control packet 32 and TS packets #k+1, . . . , #2k.

In the chaining mode of the block encryption method, the control packet 31 of the head of the first file 30a cannot utilize previous data, and hence the control packet 31 is encrypted from an intermediate block thereof.

As shown in FIG. 4, each of the control packets 31, 32, . . . , contains a first four-byte portion 41 and a subsequent 188-byte portion 42.

The subsequent 188-byte portion 42 is divided into a nonencrypted portion 43 and an encrypted portion 44.

The nonencrypted portion 43 includes a sync byte (47h) portion 45 showing the head of the transport stream and copy control information 46 (hereinafter called CCI 46) written into a predetermined position with reference to the head. The CCI 46 will be described later.

The encrypted portion 44 is formed by dividing data to be encrypted into blocks of predetermined length, and encrypting the blocks in a chaining mode which is a predetermined encrypting method.

CCI 47, which is a replica of the CCI 46, is inserted into the head position of the encrypted portion 44. A tampering detection code 48 is inserted into a position spaced from the head of the encrypted portion 44 by a distance, which corresponds to the length of one block of the block encryption, or more. The tampering detection code 48 is generated as occasion demands, and may be randomly generated by a computing technique such as random number computation or generated according to a predetermined rule.

A tampering detection code 50 of one byte or two bytes or thereabouts is stored in the authentication area 14. The tampering detection code 50 is stored as, e.g., a target to which reference is to be made during authentication complying with rule R2, in the authentication area 14 (the secure area 11) along with the encryption key.

A replica of this tampering detection code 50, i.e., an identical tampering code, is a tampering detection code 48 stored in the user area 12. The tampering detection code 48 is stored in the user area 12 in an encrypted state.

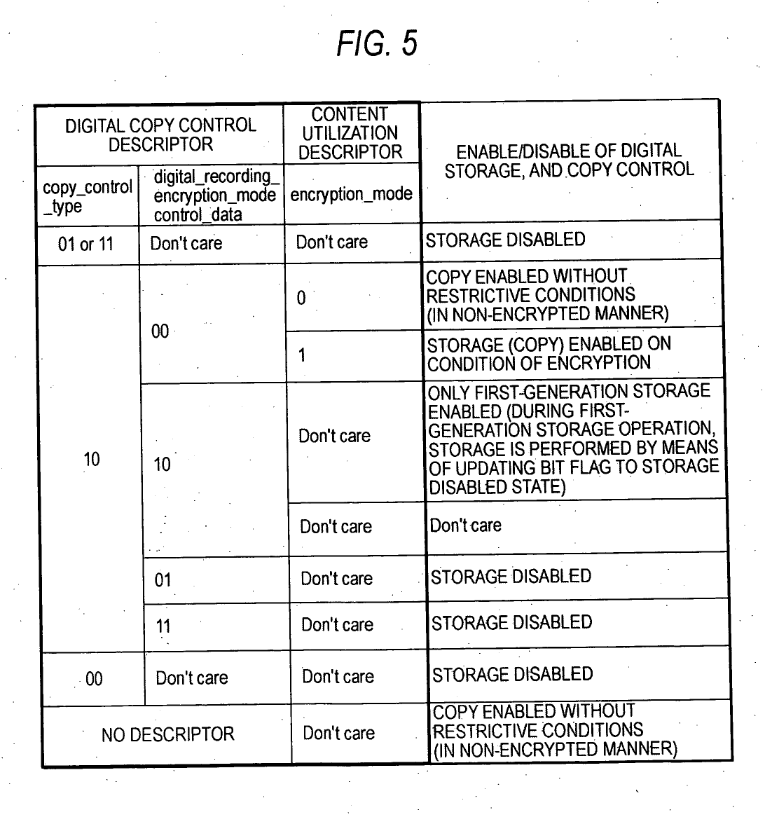

As shown in FIG. 5, a digital copy control descriptor and a content utilization descriptor are set in each of the pieces of CCI 46, 47. Each of the pieces of CCI 46, 47 is described to a data length of 8 bits or less by combination of a digital copy control descriptor and a content utilization descriptor.

Enable/disable of digital recording and descriptions of copy control can be specified by combination of the descriptors.

A copy control type and digital recording encrypting mode control data are set in the digital copy control descriptor. The type of an encryption mode is set in the content utilization descriptor.

For instance, when the copy control type is 01 or 11, recording disable is represented.

When the copy control type represents 10, the digital recording encryption mode control data represent 00, and the content utilization descriptor denotes 0, it is shown that unconditional (non-encrypted) copy is enabled.

When the copy control type represents 10 and the digital recording encryption mode control data represents 10, it is shown that only one-generation recording is enabled.

Only first-generation recording enable means that recording is performed by updating a bit flag to a recording disabled state when first-generation data is recorded.

The pieces of CCI 46, 47 correspond to information specifying conditions for reading data, such as copy freely, copy once, or copy never, when data is read.

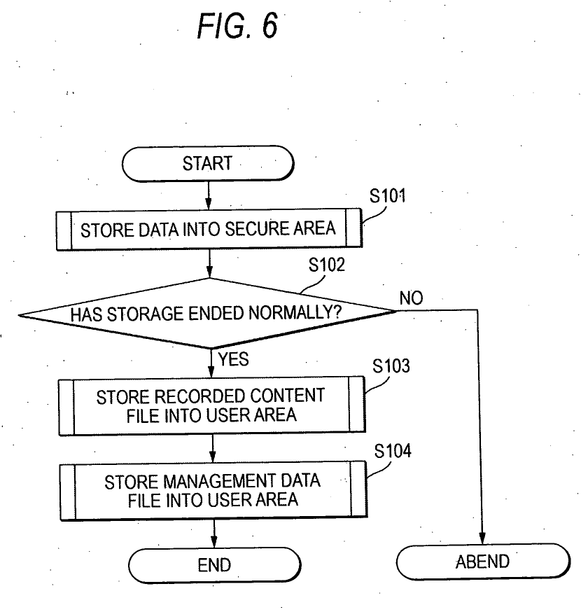

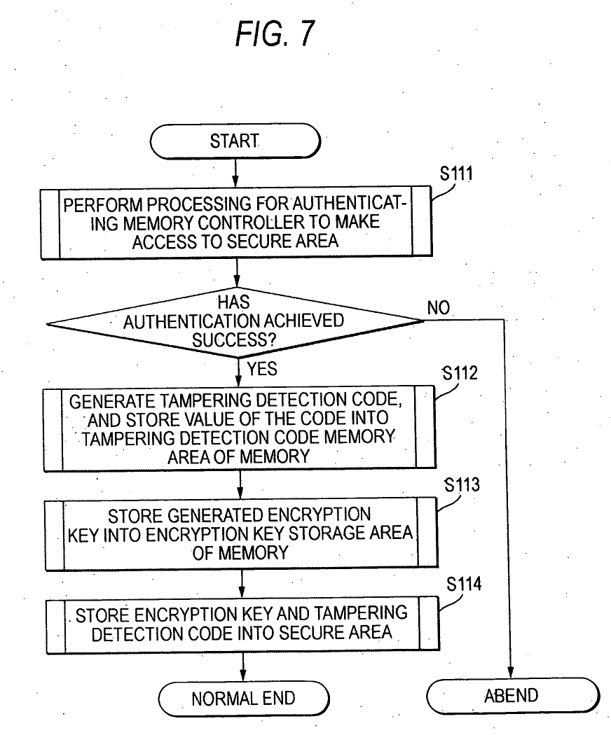

Operation for recording and playing back a program of a one-segment digital broadcast by the one-segment receiver will be described hereinbelow by reference to FIGS. 6 through 9. First, recording operation will be described.

When a certain program of one-segment digital broadcast received by the one-segment receiver is recorded in the SD memory card 10, the user selectively operates a desired program from an ordinary program watching state with a key switch 5, and the controller 7 controls the one-segment broadcast receiving tuner 2 to thus receive the program and display the program on the display 4 while buffering the program in the memory 3.

Here, when there is performed operation for recording a program by means of a recording button of the key switch 5, the controller 7 performs mutual authentication of the secure region 11 of the SD memory card 10, thereby storing an encryption key used for encrypting recording contents (block S101 in FIG. 6). Processing for storing the encryption key into the secure area 11 will be described in detail later.

The controller 7 generates a new recording directory for the user area 12.

When processing for recording the encryption key into the secure area 11 has ended normally (YES in block S102), the controller 7 stores the recorded content file 30, which corresponds to contents of the program received by the one-segment broadcast tuner 2 and converted into an MPEG2_TS format, in the directory of the user area 12 on a per-file basis (block S103).

The controller 7 stores files used for managing the recorded content file 30 (the management data file MDF1, the management file MF1, and the like), into the corresponding directory of the user area 12 (block S104).

Subsequently, processing for recording the encryption key into the secure area 11 in block S101 will be described.

In order to make access to the secure area 11 of the SD memory card 10, the controller 7 performs mutual authentication processing with the memory controller of the SD memory card 10 (block S111).

When authentication processing has been successful, the controller 7 generates a tampering detection code and an encryption key according to a predetermined rule. The controller 7 memorizes (stores) the tampering detection code into a tampering detection code storage area of the memory 3 (block S112). Then, the controller 7 memorizes (stores) the thus-generated encryption key into the encryption key storage area of the memory 3 (block S113).

Subsequently, the controller 7 stores the encryption key and the tampering detection code into the secure area 11 of the SD memory card 10 via the card I/F 6 (block S114).

Next, specific processing for storing the recorded content file 30 into the user area 12 of the SD memory card 10 will be described in detail.

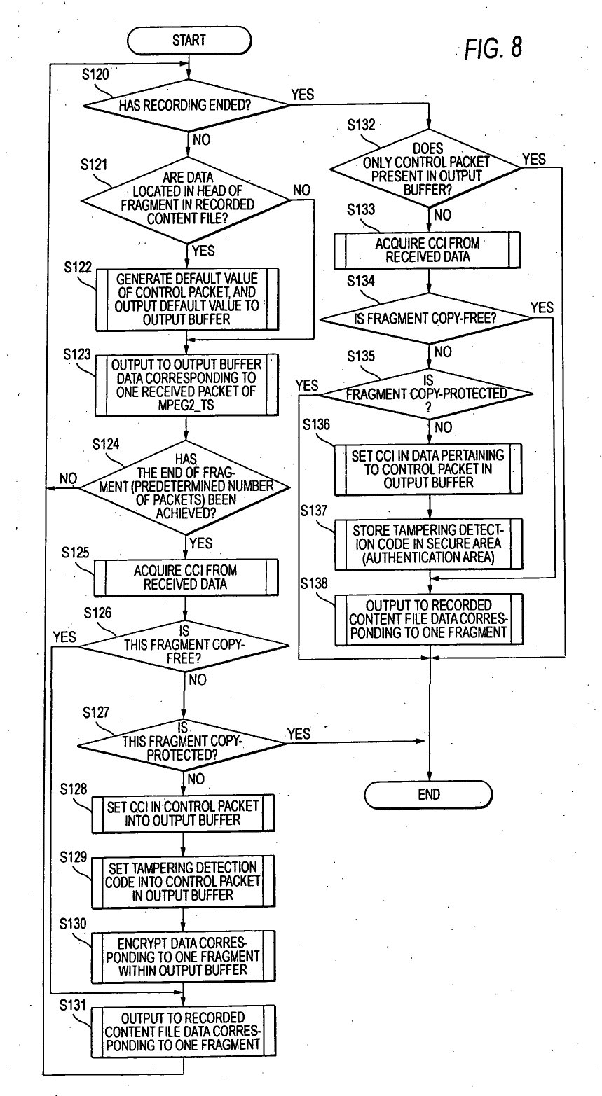

After recording operation has been started, the controller 7 monitors whether preselected recording operation has been completed by a preselected recording function or whether the key switch 5 has completed recording operation, to thus determine whether or not recording operation has been completed (block S120 in FIG. 8).

The controller 7 processes data to be recorded in the unit of one fragment containing a plurality of TS packets. When recording is determined not to have been completed as a result of determination (NO in block S120), a determination is made as to whether or not the data belong to the head of the fragment in the recorded content file 30 (block S121).

When the data belong to the head of the fragment (YES in block S121), the controller 7 generates control packet data with a default value and outputs the thus-generated control packet data to an output buffer area of the memory 3 (block S122).

When the data to be recorded do not belong to the head of the fragment (NO in block S121), the controller 7 outputs, to an output buffer area of the memory 3, data equal in volume to one packet of MPEG2_TS generated as a result of receipt of a one-segment broadcast (block S123). The controller 7 iterates processing up to the end of the fragment (block S124).

When the end of the fragment, i.e., a predetermined number of packets, has been reached (YES in block S124), the controller 7 acquires CCI included in the received data (block S125). A determination is made as to whether or not the fragment is copy freely, on the basis of the copy control type included in the digital copy control descriptor of the CCI and the digital recording encryption mode control data (block S126).

When the result of determination shows that the fragment is not copy freely (NO in block S126), the controller 7 determines whether or not the fragment is copy-protected, on the basis of CCI (block S127).

When the result of determination shows that the fragment is not copy-protected (NO in block S127), the controller 7 sets CCI 47 at the head position of the encrypted portion 44 of the control packet 31 in the output buffer (block S128).

The controller 7 sets the tampering detection code 48 from the location of CCI 47 set in the encrypted portion 44 of the control packet 31 to a position spaced from that location over a distance corresponding to the length of one block or more in the encryption method (block S129).

The controller 7 encrypts data corresponding to one fragment in the output buffer area of the memory 3 in a chaining mode (block S130).

Subsequently, the controller 7 outputs the encrypted data corresponding to one fragment to the recorded content file 30 (block S131).

Meanwhile, when recording operation is determined to have finished through processing for determining the end of recording operation in block S120 (YES in block S120), the controller 7 checks the data in the output buffer area of the memory 3, to thus determine whether or not only the control packet data is present in the output buffer area (block S132).

When the result of determination shows that the data in the output buffer area of the memory 3 is not only the control packet data (NO in block S132), the controller 7 acquires CCI from the data pertaining to the digital broadcast received by the one-segment broadcast tuner 2 (block S133), thereby determining whether or not the fragment is copy freely, on the basis of the acquired CCI (block S134).

When the result of determination shows that the fragment is not copy-free (NO in block S134), the controller 7 determines whether or not the fragment is copy-protected, on the basis of CCI (block S135).

When the result of determination shows that the fragment is not copy-protected (NO in block S135), the controller 7 sets the pieces of CCI 46, 47 and the tampering detection code 48 on the control packet data in output buffer (block S136).

At this time, the controller 7 sets (inserts) the CCI 46 into the nonencrypted area 43, and sets the CCI 47 and the tampering detection code 48 at predetermined positions in the encrypted area.

The controller 7 stores the tampering detection code 50 that is identical with the tampering detection code 48, in the authentication area 14 of the secure area 11 (block S137).

Subsequently, the controller 7 outputs the data corresponding to one fragment to the recorded content file 30, thereby storing the data into a corresponding file in the user area 12 of the SD memory card 10 (block S138).

Encryption processing pertaining to block S130 will now be described. In the one-segment receiver, for instance, a CBC mode is adopted as one chaining mode of the block encryption method. Here, CBC is an abbreviation of Cipher Book Chaining.

In the CBC mode, in order to encrypt one block, a result of encryption of the block that has been encrypted immediately before the current block is used as an input parameter. As a result, a fixed bit pattern included in plain text before being encrypted is stirred up, to thus enable encryption having a high degree of security.

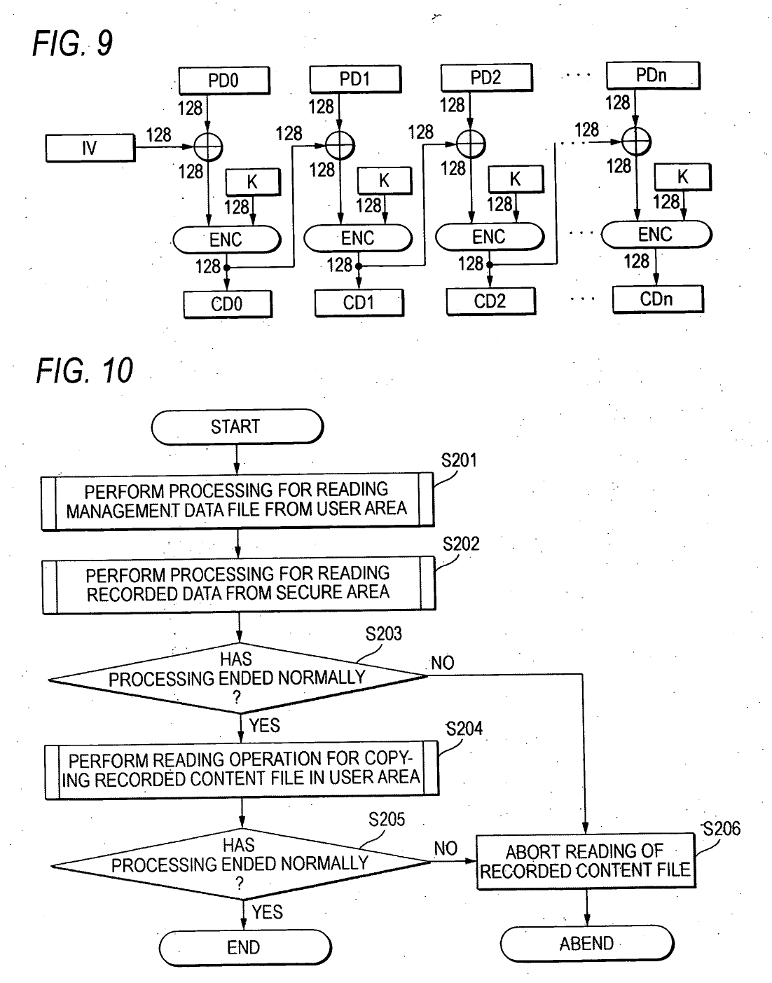

Specifically, for instance, as shown in FIG. 9, input data is divided into sets of plain data PD0 to PDn in block length (e.g., 128 bits or the like). After Exclusive-OR operation of the first plain data PD0 and an encryption initial value (IV) has been performed, the Exclusive-OR result is encrypted with an encryption key K, and the thus-encrypted exclusive-OR result is output as coded data CD0.

After exclusive-OR operation of subsequent PD1, . . . , PDn and immediately-preceding encrypted data in place of IV (CD0, . . . , CDn−1) has been performed, the exclusive-OR result is encrypted with the encryption key (K), and the thus-encrypted data is output.

Next, copying processing (reading processing) of recorded data stored in the SD memory card 10, which is performed by the one-segment receiver, will be described by reference to FIGS. 9 through 12.

In this case, the directories of the SD memory card 10 are displayed on the display 4, and the user operates the key switch 5 to select a desired recorded content file 30 from the directories. The controller 7 performs processing for reading a management file (e.g., a management file MF1) of the recorded content file 30 to be copied, from the user area 12 of the SD memory card 10 (block S201 in FIG. 10).

The controller 7 performs processing for reading an encryption key file of the authentication area 14 (in the secure area 11) specified by the data pertaining to the read management file MF1 (block S202).

When processing for reading an encryption key file has ended normally (YES in block S203), the controller 7 performs processing for reading data used for copying the recorded content file 30 of the user area 12 in the SD memory card 10 (block S204).

When processing for reading one or both of (i.e., at least one of) the data in the authentication area 14 and the data in the user area 12 has not ended normally (NO in block S203 or NO in block S205), the controller 7 determines occurrence of an a bend and aborts reading of data from the SD memory card 10 (block S206).

When processing for reading data has ended normally (YES in block S205), the controller 7 terminates processing.

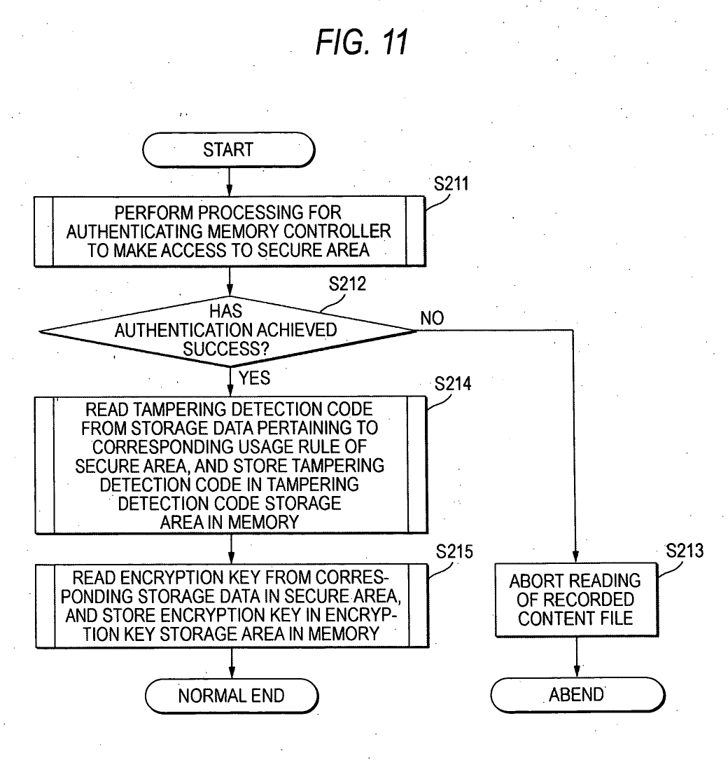

Subsequently, processing for reading data from the secure area 11 in block S202 will be described with reference to FIG. 11.

In order to make access to the secure area 11 of the SD memory card 10, the controller 7 performs mutual authentication with the memory controller of the SD memory card 10 (block S211).

During mutual authentication processing, authentication is performed by an encryption technique using parameters previously set in the memory 3 of the receiver and the secure area 11.

An authorized receiver writes, into the SD memory card 10, the data that have been encrypted by the method that can be decrypted by only an authorized SD memory card. The memory controller of the SD memory card 10 decodes the data and checks whether or not the decoded data is authorized.

When mutual authentication has ended in failure during authentication processing (NO in block S212), the controller 7 aborts processing for reading data from the authentication area 14 of the secure area 11 (block S213).

When mutual authentication has achieved success during authentication processing (YES in block S212), the controller 7 reads the tampering detection code 50 on the basis of stored data pertaining to a corresponding usage rule in the authentication area 14 of the SD memory card 10, and stores the thus-read data into the tampering detection code storage area in the memory 3 (block S214).

The controller 7 reads the encryption key of the authentication area 14 of the SD memory card 10 and stores the thus-read encryption key into the encryption key storage area of the memory 3 (block S215).

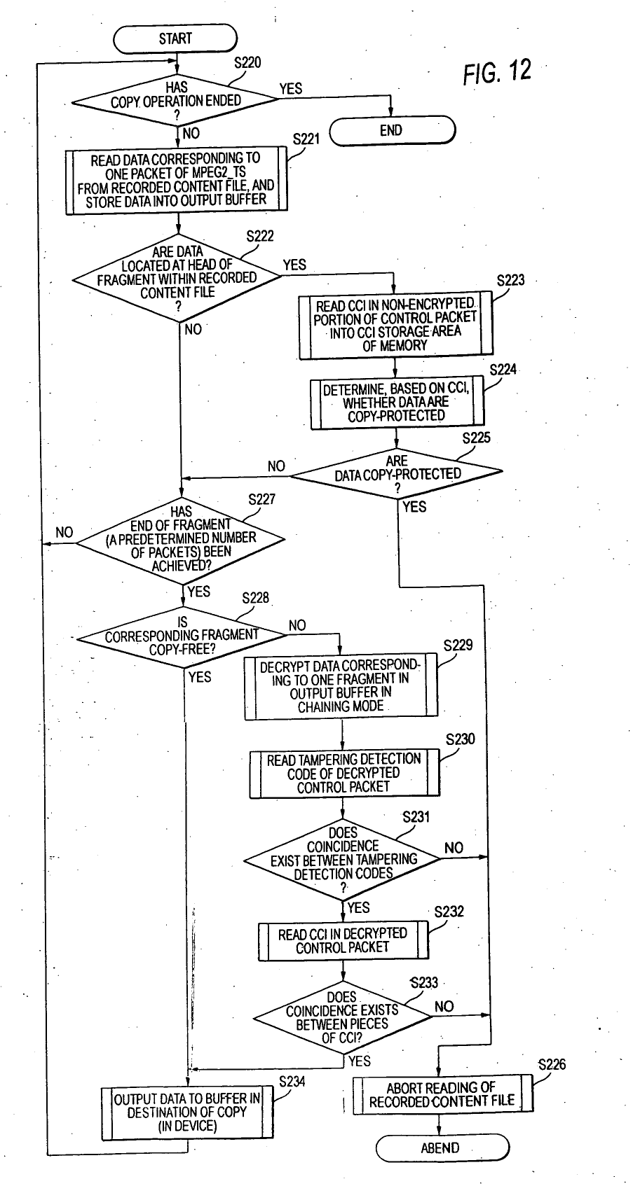

Reading operation (processing pertaining to block S204 in FIG. 10) for the purpose of copying the recorded content file 30 stored in the user area 12 of the SD memory card 10 will now be described in detail with reference to FIG. 12.

The controller 7 monitors, at all times, whether or not copy operation has ended after copy operation has been started.

When copy operation has not ended (NO in block S220 in FIG. 12), the controller 7 read data corresponding to one packet of the MPEG2_TS from the recorded content file 30 to be copied, which is stored in the user area 12 of the SD memory card 10; and stores the thus-read data into the memory 3, i.e., an output buffer (block S221). In this embodiment, although the memory 3 has also been used as an output buffer, the memory 3 and the output buffer may be separated from each other.

The controller 7 checks data corresponding to one packet read into the output buffer, and determines whether or not the data is located at the head of the fragment in the recorded content file 30 (block S222).

When the result of determination shows that the data in the output buffer is located at the head of the fragment in the recorded content file 30 (YES in block S222), the controller 7 stores the CCI 46 of the nonencrypted portion 43 of the control packet 31 into the copy control information storage area of the memory 3 (block S223).

The controller 7 performs processing for determining whether data is read, in accordance with a descriptor of the CCI 46 stored in the copy control information storage area (block S224). Through determination processing and on the basis of the CCI 46, a determination is made as to whether or not the data is copy-protected.

When the result of determination processing shows that data is determined to be copy-protected (YES in block S225), the controller 7 aborts processing for reading data (block S226), and determines occurrence of an abend, thereby terminating copy of the recorded content file 30 which is an object of copying.

When determination processing shows that the data is copy-enabled (NO in block S225), the controller 7 determines whether or not the data read packet by packet is at the end of the fragment, i.e., a predetermined number of packets, has been reached (block S227).

When the data read packet by packet is determined to have reached the predetermined number of packets through determination of the result, the controller 7 checks whether or not the fragment is copy-freely, on the basis of CCI 46.

When the fragment is not copy-freely (NO in block S228), the controller 7 decodes data corresponding to one fragment of the output buffer in a chaining mode (a CBC mode), which is a predetermined decryption method (block S229) Decryption processing will be described later.

After decryption, the controller 7 reads the tampering detection code 48 from the decrypted control packet (block S230), and temporarily stores the code in the memory 3.

The controller 7 reads the tampering detection code 50 previously stored in the authentication area 14, and compares the tampering detection code 50 with the tampering detection code 48 temporarily stored in the memory 3 (block S231).

When the result of comparison shows that no coincidence exists between the tampering detection codes 48, 50 (NO in block S231), the controller 7 aborts processing for reading data (block S226).

When the result of comparison shows that coincidence exists between the tampering detection codes 48, 50 (YES in block S231), the controller 7 reads the CCI 47 from the decrypted control packet (block S232).

The thus-read CCI 47 is compared with the CCI 46 of the nonencrypted portion 43 previously stored in the copy control information storage area of the memory 3 (block S233)

When the result of comparison shows that no coincidence exists between the pieces of CCI 46, 47 (NO in block S233), the controller 7 aborts processing for reading data (block S226).

When the result of comparison shows that coincidence exists between the pieces of CCI 46, 47 (YES in block S233), the controller 7 outputs the data temporarily stored in the memory 3 to a buffer in a destination of copying (block S234).

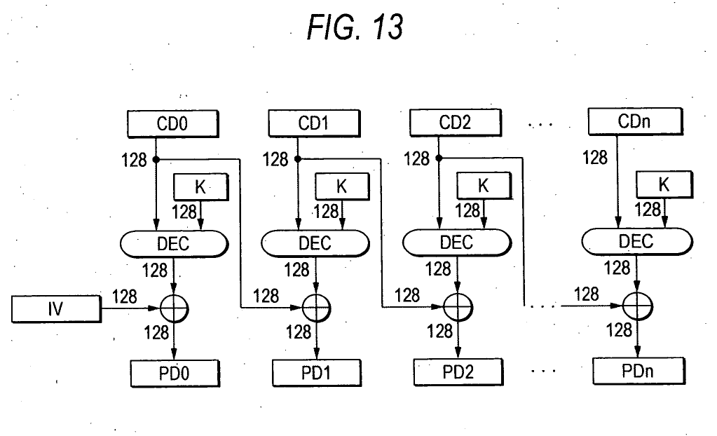

Decryption processing pertaining to block S229 will now be described with reference to FIG. 13. As mentioned previously, the one-segment receiver adopts a CBC mode as one chaining mode of the block encryption method, and decrypts data in the CBC mode.

Specifically, as shown in FIG. 13, input data is divided into coded data CD0 to CDn in block lengths (e.g., 128 bits). The first coded data CD0 is decrypted by the key (K); exclusive-OR operation is performed on the decrypted first data and the encryption initial value (initial value: IV); and the thus-obtained exclusive-OR result is output as a first plain data PD0. The coded data CD1, . . . , CDn are decrypted by the key (K); exclusive-OR operation is performed on the decrypted data and immediately-before encryption data in place of IV (CD0, . . . , CDn−1); and exclusive-OR results are output.

As mentioned above, in the one-segment receiver of the present embodiment, when CCI is recorded in an encrypted form in the user area 12 of the SD memory card 10 where the user can easily make access, CCI is stored while being divided into the nonencrypted portion 43 and the encrypted portion 44. In relation to the encrypted portion 44, block encryption is performed in the CBC mode (the chaining mode), and the CCI 47 is placed at the head of the encrypted portion 44. The tampering detection code 48 is located at a position which is spaced apart from the position of the CCI 47 over at least a distance corresponding to the length of one block or more.

The tampering detection code 50 identical with the tampering detection code 48 is stored in a secure recording area (the authentication area 14) of the SD memory card 10 to which the user cannot readily make access, along with the encryption key K. When data is copied or read, comparison between the tampering detection codes 48, 50 as well as comparison between the pieces of CCI 46, 47 is performed to thus check coincidence, thereby determining whether or not the packet data have been tampered with.

When mismatch is determined to exist in any one of the results of comparison, the controller 7 determines that tampering has been performed, thereby aborting reading of data. Hence, while the pieces of CCI 46, 47 are stored in the user area 12, copy or playback of data, which would otherwise be performed by unauthorized activity or by tampering with data, can be prevented. As a result of the pieces of CCI 46, 47 being stored in the user area 12, the necessity for making access to the secure area 11 according to changes in CCI, which has hitherto been performed, can be obviated. This method can be applied to a data processor used in a device such as a portable terminal having comparatively low processing performance.

The present invention is not limited solely to the embodiment. The embodiment has described a case where the tampering detection codes 48, 50 are determined by computation such as generation of random numbers. In addition to the embodiment, the tampering detection code may be, e.g., a predetermined value; namely, a fixed value.

The tampering detection codes 48, 50 maybe computed by means of a CRC code technique, a checksum technique, or the like. In this case, when a CRC code is used, the area from the head of data to be encrypted to the position of the tampering detection code 48 will be checked.

The chaining mode in the CBC mode is a mere example. The block encryption method includes various chaining modes other than the CBC mode. For instance, a CFB (Cipher Feedback) mode, an OFB (Output Feedback) mode, and the like, may be applied to the present invention.

For instance, the chaining mode based on the CBC mode includes an C-CBC mode, an FCBC mode, an XCBC mode, and the like. These modes may be applied to the present invention. The C-CBC mode has a C2 algorithm defined in CPRM.

The tampering detection codes 48, 50 may be a value which is obtained as a parameter by predetermined computation of the value recorded in the authentication area 14. In addition to being a code, the tampering detection code 48 may be a flag or a check bit.

It is to be understood that the present invention is not limited to the specific embodiment described above and that the invention can be embodied with the elements modified without departing from the spirit and scope of the invention. The present invention can be embodied in various forms according to appropriate combinations of the elements disclosed in the embodiment described above. For example, some elements may be deleted from all elements shown in the embodiment. Further, the elements in different embodiments maybe used appropriately in combination.

What is claimed is:

1. A data processing method of a data processor for storing data into a recording medium having a first storage area which allows access from only specific applications complying with a copyright protection technique and a second storage area which allows access from the specific applications and other applications, the data processing method comprising:
generating a packet having a nonencrypted portion including copy control information showing conditions for copying the data and an encrypted portion including the copy control information and predetermined information arranged at predetermined positions; and
storing a file containing a plurality of generated packets into the second storage area of the recording medium.

2. The data processing method according to claim 1, further comprising:
placing the copy control information at a start position of a block in the encrypted portion;
placing the predetermined information at a position spaced from the position by a distance corresponding to the length of one block or more in the encrypted portion; and
encrypting data in relation to the encrypted portion on a per-block basis by means of a block encryption method.

3. The data processing method according to claim 2, wherein data is encrypted by use of a chain mode in the block encryption method.

4. A data processor for processing data stored in a recording medium having a first storage area which allows access from only specific applications complying with a copyright protection technique and a second storage area which allows access from the specific applications and other applications, the data processor comprising:
a packet generating unit configured to read an encrypted file from the second storage area of the storage medium when reading of data stored in the storage medium is instructed, thereby generating a plurality of packets, each of which has a nonencrypted portion including copy control information showing conditions for copying the data and an encrypted portion including the copy control information and predetermined information arranged at predetermined positions;
a first determining unit configured to determine whether or not the predetermined information has been tampered with, by use of the predetermined information obtained by decrypting the encrypted portion of each of the packets according to a predetermined encrypting method as well as information read from the first storage area;
a second determining unit configured to determine whether or not coincidence exists by means of comparing the copy control information obtained by decrypting the encrypted portion of each of the packets according to a predetermined encrypting method with copy control information obtained from the nonencrypted portion of the packet, thereby determining whether or not the copy control information has been tampered with; and
a read control unit configured to abort reading of data when the copy control information is determined to have been tampered with based on one of results of the first determining unit and the second determining unit.

5. The data processor according to claim 4, wherein, when data in relation to the encrypted portion of data stored in the storage medium is decrypted on a per-block basis according to a block decryption method, the copy control information is acquired from a start position of a block, and the predetermined information is acquired from a position spaced from the position by a distance corresponding to the length of one block or more.

6. A data processor for processing data stored in a recording medium having a first storage area which allows access from only specific applications complying with a copyright protection technique and a second storage area which allows access from the specific applications and other applications, the data processor comprising:
a data management information reading unit configured to read data management information from the second storage area of the storage medium when reading of desired data stored in the storage medium is instructed;
a packet data reading unit configured to read packet data, which has a nonencrypted portion and an encrypted portion, from an encrypted file of the second storage area;
a storing unit configured to store the read packet data, and copy control information included in the nonencrypted portion of the packet, into a memory;
a decrypting unit configured to decrypt data pertaining to the encrypted portion of the packet in a chain mode of a block cipher, through use of an encryption key specified by the data management information stored in the first storage area;
a first determining unit configured to determine whether or not the predetermined information has been tampered with, by use of predetermined information included in data pertaining to a decrypted portion and information read from the first storage area;
a second determining unit configured to determine whether or not coincidence exists by means of comparing the copy control information included in data pertaining to the decrypted portion with copy control information about the nonencrypted portion stored in the memory, thereby determining whether or not the copy control information has been tampered with; and
a read control unit configured to abort reading of data into memory when the copy control information is determined to have been tampered with based on one of results of the first determining unit and the second determining unit.

7. The data processor according to claim 6, wherein, when data in relation to the encrypted portion of data stored in the storage medium is decrypted on a per-block basis according to a block decryption method, the copy control information is acquired from a start position of a block, and the predetermined information is acquired from a position spaced from the position by a distance corresponding to the length of one block or more.
